(19) United States
(12) Patent Application Publication
(10) Pub. No.: US 2025/0199949 A1
(43) Pub. Date: Jun. 19, 2025

(54) DATA NETWORK ARCHITECTURE

(71) Applicant: Tusas- Turk Havacilik Ve Uzay Sanayii Anonim Sirketi, Kahramankazan (TR)

(72) Inventors: Lütfi KOSE, Kahramankazan (TR); Muhammed Hasan TOPCU, Kahramankazan (TR)

(73) Assignee: Tusas- Turk Havacilik Ve Uzay Sanayii Anonim Sirketi, Kahramankazan (TR)

(21) Appl. No.: 18/934,279

(22) Filed: Nov. 1, 2024

(30) Foreign Application Priority Data
Dec. 15, 2023 (TR) 2023/017398

(51) Int. Cl. G06F 12/02

(52) U.S. Cl. CPC G06F 12/023

(57) ABSTRACT

The present invention relates to at least one equipment (2) configured to perform the function specified by the user and/or manufacturer, at least one source (3) providing data to the equipment (2), and at least one live data storage (4) that is connected to the source (3) and enables the storing of live data (L) provided directly by the source (3).

### RELATED APPLICATIONS

This application is a Paris Convention, which claims the benefit of priority of Turkish Patent Application No. 2023/017398 filed on Dec. 15, 2023. The contents of the above application is all incorporated by reference as if fully set forth herein in its entirety.

### FIELD AND BACKGROUND OF THE INVENTION

This invention relates to the processing and use of data using artificial intelligence.

A digital twin is a digital copy of an object or entity. This copy can be used to collect information about a real-world entity, analyse it, and predict its future behaviour. It is a virtual system that covers the life cycle of an object or system, updated with real-time data, and helps with decision-making. Digital twins are models of specific real-world entities equipped with sensors that continuously update their virtual counterparts with granular, high-quality data in real time, unlike simulations that operate in completely virtual environments isolated from the outside world. Digital twins, equipped with up-to-date data about physical objects, use artificial intelligence and machine learning to create detailed predictive models and predict accurate results.

When creating a prediction algorithm, it is necessary to first complete machine learning by providing data to the unit in which the algorithm will rotate. When providing data, data losses occur due to the devices located between the data source and the machine learning unit, and a high storage volume is required.

In the Chinese patent document numbered CN110428613A in the state of the art, a machine learning intelligent traffic situation prediction method is mentioned, in which after collecting traffic data sets, they are transferred to a LSTM (Long Short Term Memory) based model and modelled with road data information, data sets are pre-processed and stored, and forecast values are obtained by creating an LSTM model with the stored traffic and weather data.

### SUMMARY OF THE INVENTION

By means of a data network architecture developed with the present invention, it is possible to create a prediction model using less data.

Another aim of this invention is to ensure that the unit to be provided with data is not affected by data interruption by transferring learned data to the unit to be provided with data in the event that no data is received from the data source.

The data network architecture defined in the first claim and the claims dependent on this claim, which is realised to achieve the aim of the invention, comprises at least one equipment performing any function. At least one source is connected to the equipment and ensures the operation of the equipment or supports the equipment. There is at least one live data storage that is physically or wirelessly connected to the source and comprises instant data and/or data series provided by the source.

The data network architecture that is the subject of the invention comprises at least one control unit that is physically or wirelessly connected to the source. At least one meaningful data storage is connected to the control unit and provides the storage of meaningful data (M) created as a result of processing the live data (L) transmitted by the source to the control unit. The control unit instantly checks the live data (L) that comes from the source and are located in the live data storage and the meaningful data (M) that are located in the meaningful data storage, and updates the meaningful data (M) that are located in the meaningful data storage according to the live data (L) that are located in the live data storage and ensures the data transfer from the meaningful data storage to the source or equipment. Thus, in case of an interruption in the live data (L) coming from the source, the meaningful and up-to-date forecast data model that is located in the meaningful data storage is transferred to the source or equipment, ensuring that the source or equipment is not affected by the data interruption.

In one embodiment of the invention, the data network architecture comprises a control unit that is subjected to learning to interpret data with an artificial neural network-based data interpretation method by providing data from the source at a time and intensity determined by the user or manufacturer according to the function to be performed by the equipment.

In one embodiment of the invention, the data network architecture comprises a control unit that creates a prediction model by creating meaningful data (M) using live data (L) directly provided from the source during the data interpretation process. The fact that there is no interface between the control unit and the source while interpreting the data ensures that the data interpretation process is completed with less data and by providing data for a shorter period of time, allowing the live data storage and the meaningful data storage to work with low data storing. The learning data in the meaningful data storage is deleted when the data interpretation process is completed. The live data (L) in the live data storage is constantly updated with new data coming from the source. The meaningful data (M) model in the meaningful data storage is constantly updated by means of the live data (L) transferred to the control unit by the live data storage.

In one embodiment of the invention, the data network architecture comprises at least one buffer that is connected to the source. The buffer provides the data storing order to the live data storage and the meaningful data storage and the temporary storage of the data before it is written to the live data storage and the meaningful data storage. before the live data (L) from the source is written to the live data storage and/or before the meaningful data (M) that is given meaning during updating and/or data interpretation in the control unit (M) is written to the meaningful data storage.

In one embodiment of the invention, the data network architecture comprises at least one external storage that is connected to the meaningful data storage. The external storage provides long-term and high storage density storing of meaningful data (M) in the meaningful data storage for backup purposes before transferring it to the equipment or source.

In one embodiment of the invention, the data network architecture comprises a control unit that enables the processing of live data (L) or data set transmitted by the source during the data interpretation process using the recurrent neural network-based learning method and the creation of meaningful data (M). After the data interpretation process is completed, the control unit ensures that the meaningful data (M) created while the equipment is performing its function is continuously updated according to the live data (L) provided by the source. The control unit provides the feeding of the source and/or equipment with the updated meaningful data (M). The control unit feeds the equipment and/or source with the current meaningful data (L) set in the meaningful data storage in case of an interruption in the live data (L) provided by the source. The control unit allows the storing of meaningful data (L) in the meaningful data storage into the external storage for a long time and with a high data storage density.

In one embodiment of the invention, the data network architecture comprises a communication tool that enables data exchange between the source, equipment, control unit, live data storage, meaningful data storage, external storage and buffer.

In one embodiment of the invention, the data network architecture comprises a control unit in which meaningful data (M) is created using a recurrent neural network-based learning method prior to aircraft and/or spacecraft flight. The control unit, which performs data interpretation before the flight of the aircraft and/or spacecraft, is continuously updated by the source during the flight by transferring live data (L).

In one embodiment of the invention, the data network architecture comprises equipment that is used in the aircraft and/or spacecraft.

In one embodiment of the invention, the data network architecture comprises a source that is used in the aircraft and/or spacecraft.

### BRIEF DESCRIPTION OF SEVERAL VIEWS OF THE DRAWINGS

The data network architecture realised to achieve the aim of this invention is shown in the attached figures, and of these figures;

FIG. 1—shows the schematic view of the data network architecture during the data interpretation process.

FIG. 2—shows the schematic view of the data network architecture after the data interpretation process is completed.

### DESCRIPTION OF SPECIFIC EMBODIMENTS OF THE INVENTION

The parts in the figures are numbered one by one and the equivalents of these numbers are given below.
1. Data network architecture
2. Equipment
3. Source
4. Live data storage
5. Control unit
6. Meaningful data storage
7. Buffer
8. External storage
9. Communication tool
(L) Live data
(M) Meaningful data

The data network architecture (1) comprises at least one equipment (2) configured to perform the function specified by the user and/or manufacturer, at least one source (3) providing data to the equipment (2), and at least one live data storage (4) that is connected to the source (3) and enables the storing of live data (L) provided directly by the source (3).

The data network architecture (1) that is the subject of the invention comprises at least one control unit (5) that is connected to the source (3), at least one meaningful data storage (6) that is connected to the control unit (5) and enables the storing of meaningful data (M) generated by processing the live data (L) that is transmitted by the source (3) to the control unit (5), and the control unit (5) that controls the data in the live data storage (4) and the meaningful data storage (6) simultaneously with the data flow, updates the meaningful data (M) in the meaningful data storage (6) according to the live data (L) in the live data storage (4) and transfers meaningful data from the meaningful data storage (6) to the equipment (2) and/or source (3), thus ensures that the source (3) and/or equipment (2) operates almost completely unaffected by the data interruption in the event of an interruption in the data flow transmitted from the source (3) to the live data storage (4).

Preferably, there is equipment (2) that is used on the aircraft and performs the function determined by the manufacturer or user. Preferably, there is a source (3) that is used on the aircraft and provides data to the equipment (2). The live data storage (4) is connected to the source (3) and ensures the storing of live data (L) provided by the source (3).

There is a control unit (5) connected to the source (3). The meaningful data storage (6) is connected to the control unit (5) and ensures the storing of meaningful data (M) created in the control unit (5) by processing the live data (L) transmitted by the source (3) to the control unit (5). There is a control unit (5) that simultaneously checks the data in the meaningful data storage (6) with the data in the live data storage (4) in which the live data (L) coming from the source (3) is located and updates the data in the meaningful data storage (6) according to the data in the live data storage (4). In case of an interruption in the data flow transmitted from the source (3) to the live data storage (4), the control unit (5) feeds the equipment (2) with the current data set that has been interpreted to ensure that the source (3) and/or equipment (2) operates without being affected by the data interruption. (FIG. 2)

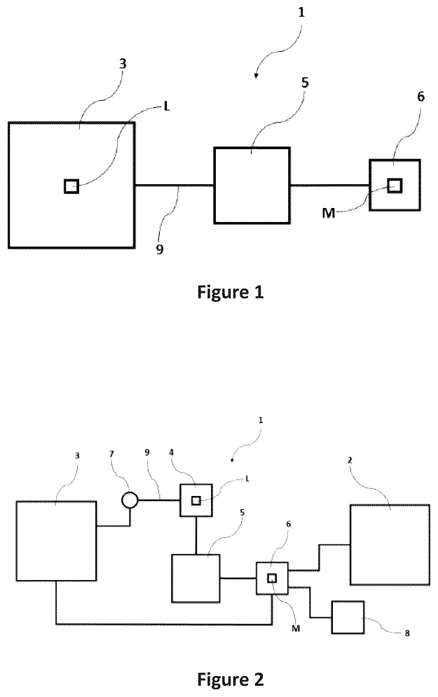

In one embodiment of the invention, the data network architecture (1) comprises a control unit (5) in which meaningful data (M) is created using a recursive neural network-based machine learning algorithm such as LSTM or Transfer Learning by providing data from the source (3) in a volume determined by the user or manufacturer. The creation of meaningful data (M) in the control unit (5) is done before the equipment (2) performs its function. (FIG. 1)

In one embodiment of the invention, the data network architecture (1) comprises a control unit (5) that allows the live data storage (4) and the meaningful data storage (6) to have a low storage volume by being directly connected to the source (3), thus allowing the meaningful data (M) to be created by providing less data from the source (3) and representing the source (3) with less data.

In an embodiment of the invention, the data network architecture (1) comprises at least one buffer (7) that is connected to the source (3), is the unit where data is temporarily stored to ensure that the data coming from the source (3) is stored in the live data storage (4) and/or the meaningful data storage (6), and enables the data storing order to be given to the live data storage (4) and/or the meaningful data storage (6). In this way, faster data communication between the source (3) and the equipment (2) is ensured.

In an embodiment of the invention, the data network architecture (1) comprises at least one external storage (8) that is connected to the second storage (6), ensures that the meaningful data (M) in the meaningful data storage (6) is controlled and updated by the control unit (5) and that the updated meaningful data (M) is stored before being transferred to the equipment (2) and/or source (3), and has high storage volume.

In an embodiment of the invention, the data network architecture (1) comprises a control unit (5) that enables performing the process steps of processing the live data (L) or data series transmitted by the source (3) with the recurrent neural network-based learning algorithm and creating meaningful data (M) (101), checking the live data (L) in the live data storage (4) according to the meaningful data (M) in the meaningful data storage (6) simultaneously with the data flow according to the meaningful data created and updating the meaningful data (M) (102), feeding the source (3) and/or equipment (2) with updated meaningful data (M) (103), and long-term storing of meaningful data (M) in external storage (8) (104).

In one embodiment of the invention, the data network architecture (1) comprises at least one communication tool (9) that provides data transmission between the equipment (2), the control unit (5) and the source (3) and has a data transmission interface determined by the user. The communication tool (9) provides wired communication and/or wireless communication.

In one embodiment of the invention, the data network architecture (1) comprises a control unit (5) in which meaningful data (M) is generated using a recurrent neural network-based learning algorithm prior to the flight of the aircraft and/or spacecraft.

In one embodiment of the invention, the data network architecture (1) comprises equipment (2) that is located on the aircraft and/or spacecraft. The equipment (2) is preferably a flight control computer.

In one embodiment of the invention, the data network architecture (1) comprises a source (3) that is located on the aircraft and/or spacecraft. The source (3) is preferably a temperature sensor, pressure sensor, etc.

1. A data network architecture (1) comprising at least one equipment (2) configured to perform the function specified by the user and/or manufacturer, at least one source (3) providing data to the equipment (2), and at least one live data storage (4) that is connected to the source (3) and enables the storing of live data (L) provided directly by the source (3) characterised by at least one control unit (5) that is connected to the source (3), at least one meaningful data storage (6) that is connected to the control unit (5) and enables the storing of meaningful data (M) generated by processing the live data (L) that is transmitted by the source (3) to the control unit (5), and the control unit (5) that controls the data in the live data storage (4) and the meaningful data storage (6) simultaneously with the data flow, updates the meaningful data (M) in the meaningful data storage (6) according to the live data (L) in the live data storage (4) and transfers meaningful data from the meaningful data storage (6) to the equipment (2) and/or source (3), thus ensures that the source (3) and/or equipment (2) operates almost completely unaffected by the data interruption in the event of an interruption in the data flow transmitted from the source (3) to the live data storage (4).

2. A data network architecture (1) according to claim 1, characterised by the control unit (5) in which meaningful data (M) is created using a recurrent neural network-based machine learning algorithm by providing data from the source (3) in a volume determined by the user or manufacturer.

3. A data network architecture (1) according to claim 1, characterised by the control unit (5) that allows the live data storage (4) and the meaningful data storage (6) to have a low storage volume by being directly connected to the source (3), thus allowing the meaningful data (M) to be created by providing less data from the source (3).

4. A data network architecture (1) according to claim 1, characterised by at least one buffer (7) that is connected to the source (3), is the unit where data is temporarily stored to ensure that the data coming from the source (3) is stored in the live data storage (4) and/or the meaningful data storage (6), and enables the data storing order to be given to the live data storage (4) and/or the meaningful data storage (6).

5. A data network architecture (1) according to claim 1, characterised by at least one external storage (8) that is connected to the second storage (6), ensures that the meaningful data (M) in the meaningful data storage (6) is controlled and updated by the control unit (5) and that the updated meaningful data (M) is stored before being transferred to the equipment (2) and/or source (3), and has high storage volume.

6. A data network architecture (1) according to claim 1, characterised by the control unit (5) enabling the performing of the process steps of:
processing the live data (L) or data series transmitted by the source (3) with the recurrent neural network-based learning algorithm and creating meaningful data (M) (101),
checking the live data (L) in the live data storage (4) according to the meaningful data (M) in the meaningful data storage (6) simultaneously with the data flow according to the meaningful data created and updating the meaningful data (M) (102),
feeding the source (3) and/or equipment (2) with updated meaningful data (M) (103), and
long-term storing of meaningful data (M) in external storage (8) (104).

7. A data network architecture (1) according to claim 1, characterised by at least one communication tool (9) that provides data transmission between the equipment (2), the control unit (5) and the source (3) and has a data transmission interface determined by the user.

8. A data network architecture (1) according to claim 1, characterised by the control unit (5) in which meaningful data (M) is generated using a recurrent neural network-based learning algorithm prior to the flight of the aircraft and/or spacecraft.

9. A data network architecture (1) according to claim 1, characterised by the equipment (2) that is located on the aircraft and/or spacecraft.

10. A data network architecture (1) according to claim 1, characterised by a source (3) that is located on the aircraft and/or spacecraft.
